(19) United States
(12) Patent Application Publication
(10) Pub. No.: US 2013/0059597 A1
(43) Pub. Date: Mar. 7, 2013

(54) MOBILE DEVICE INCLUDING ZIGBEE MODULE AND METHOD OF OPERATION THEREOF

(71) Applicant: Chan Yong JEONG, Seoul (KR)

(72) Inventor: Chan Yong JEONG, Seoul (KR)

(73) Assignee: SAMSUNG ELECTRO-MECHANICS CO., LTD.

(21) Appl. No.: 13/333,305

(22) Filed: Dec. 21, 2011

(30) Foreign Application Priority Data
Sep. 2, 2011 (KR) 10-2011-0088997

(51) Int. Cl. H04W 52/02; H04W 24/00

(52) U.S. Cl. 455/456.1; 455/41.2

(57) ABSTRACT

There are provided a mobile device including a Zigbee module and an method of operation thereof. The mobile device includes: a power supply unit; a Zigbee module operated by receiving power supplied from the power supply unit and connected to external electronic devices so that the Zigbee module communicates with the external electronic devices, to thereby provide a remote control function; and a switching unit controlling a connection between the power supply unit and the Zigbee module, wherein the power supply unit includes a main power supply unit and an auxiliary power supply unit supplying power to the Zigbee module when residual power in the main power supply unit falls to a predetermined reference value or less, whereby the remote control function and the position tracking function using the mobile device can be provided even when there is no sufficient residual power therein.

### CROSS-REFERENCE TO RELATED APPLICATIONS

This application claims the priority of Korean Patent Application No. 10-2011-0088997 filed on Sep. 2, 2011 in the Korean Intellectual Property Office, the disclosure of which is incorporated herein by reference.

### BACKGROUND OF THE INVENTION

1. Field of the Invention

The present invention relates to a mobile device including a Zigbee module, capable of being operated as a remote control of other electronic devices and providing a position tracking function, even when a main power supply is turned-off, and an method of operation thereof.

2. Description of the Related Art

With the wide distribution of a mobile device having various functions implemented therein, such as a smart phone, users can enjoy mobile functions, such as voice calls, transmitting and receiving text messages, or the like, as well as various other functions, such as broadcasts received through digital media broadcasting (DMB), access to Internet services, such as shopping, Navigation, and the like, in a single mobile device. In particular, services providing a remote control function for other home appliances, for example, a smart TV, a Blu-ray (or DVD) player, a home theater, or the like, by a mobile device, such as a smart phone, or the like, according to type, such as WIFI, Bluetooth, infrared communication, or the like, have recently been distributed.

When a mobile device, such as a smart phone, is implemented with the remote control function, an infrared (IR) remote control widely used in the related art does not need to be separately arranged. Further, the mobile device can be implemented more variously and efficiently as a remote controller when considering the characteristics of a smart phone having less restrictions in terms of functions, unlike the IR remote control according to the related art. In addition, when the remote control function is implemented by communication type, such as WIFI, Bluetooth, or the like, restrictions on the directivity of the remote control may be reduced differently from the IR type, and as a result, the remote control may be used more conveniently.

However, when the remote control function is implemented according to communication type such as WIFI, Bluetooth, or the like, the communication type, such as WIFI, Bluetooth, or the like, may have relatively high power consumption, such that rapid consumption of battery power, indicated as one of great drawbacks of smart phones, may occur. In addition, when residual battery power is not high, the function as the remote control may not be properly performed.

### SUMMARY OF THE INVENTION

An aspect of the present invention is to provide a mobile device including a Zigbee module, capable of implementing a remote control function for home appliances and providing a position tracking function with low power consumption, and an method of operation thereof.

According to an aspect of the present invention, there is provided a mobile device, including: a power supply unit; a Zigbee module operated by power supplied from the power supply unit and connected to an external electronic device so as to communicate with the external electronic device, to thereby provide a remote control function; and a switching unit controlling a connection between the power supply unit and the Zigbee module; wherein the power supply unit includes a main power supply unit and an auxiliary power supply unit supplying power to the Zigbee module when residual power in the main power supply unit falls to a predetermined reference value or less.

The auxiliary power supply unit may be disposed in the Zigbee module.

The switching unit may be disposed in the Zigbee module.

The switching unit may connect the auxiliary power supply unit to the Zigbee module so that the Zigbee module may receive the power supplied from the auxiliary power supply unit when the residual power in the main power supply unit is 5% or less.

The switching unit may connect the main power supply unit to the Zigbee module so that the Zigbee module may receive power supplied from the main power supply unit when the residual power in the main power supply unit is 5% or more.

The Zigbee module may transmit a signal in response to a position tracking signal to the external electronic devices when receiving the position tracking signal from the external electronic devices.

The mobile device may further include a mechanical input unit controlling an operation of the remote control function provided by the Zigbee module.

According to another aspect of the present invention, there is provided a method of operation of a mobile device including a Zigbee module, the method of operation including: confirming residual power in a main power supply unit; supplying power to the Zigbee module from at least one of the main power supply unit and an auxiliary power supply unit according to the residual power in the main power supply unit; and providing a remote control function for external electronic devices by connecting the external electronic devices to the Zigbee module so as to communicate with each other.

The supplying of the power may include supplying the power from the auxiliary power supply unit to the Zigbee module when the residual power in the main power supply unit is at a predetermined reference value or less, and supplying the power from the main power supply unit to the Zigbee module when the residual power in the main power supply unit is at the reference value or more.

The reference value may be a 5% of maximum power of the main power supply unit.

The method of operation may further include transmitting a signal in response to a position tracking signal to the external electronic devices when receiving the position tracking signal from the external electronic devices.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram showing an appearance of a mobile device according to an embodiment of the present invention;

FIG. 2 is a block diagram partially showing an inner structure of the mobile device according to the embodiment of the present invention;

FIG. 3 is a flow chart for explaining an method of operation of the mobile device according to the embodiment of the present invention; and

FIGS. 4 and 5 are diagrams schematically showing the method of operation of the mobile device according to the embodiment of the present invention.

### DETAILED DESCRIPTION OF THE INVENTION

Embodiments of the present invention will be described in detail with reference to the accompanying drawings. These embodiments will be described in detail for those skilled in the art in order to practice the present invention. It should be appreciated that various embodiments of the present invention are different but do not have to be exclusive. For example, specific shapes, configurations, and characteristics described in an embodiment of the present invention may be implemented in another embodiment without departing from the spirit and the scope of the present invention. In addition, it should be understood that position and arrangement of individual components in each disclosed embodiment may be changed without departing from the spirit and the scope of the present invention. Therefore, a detailed description described below should not be construed as being restrictive. In addition, the scope of the present invention is defined only by the accompanying claims and their equivalents if appropriate. The similar reference numerals will be used to describe the same or similar functions throughout the accompanying drawing.

Hereinafter, embodiments of the present invention will be described in detail with reference to the accompanying drawings so that those skilled in the art may easily practice the present invention.

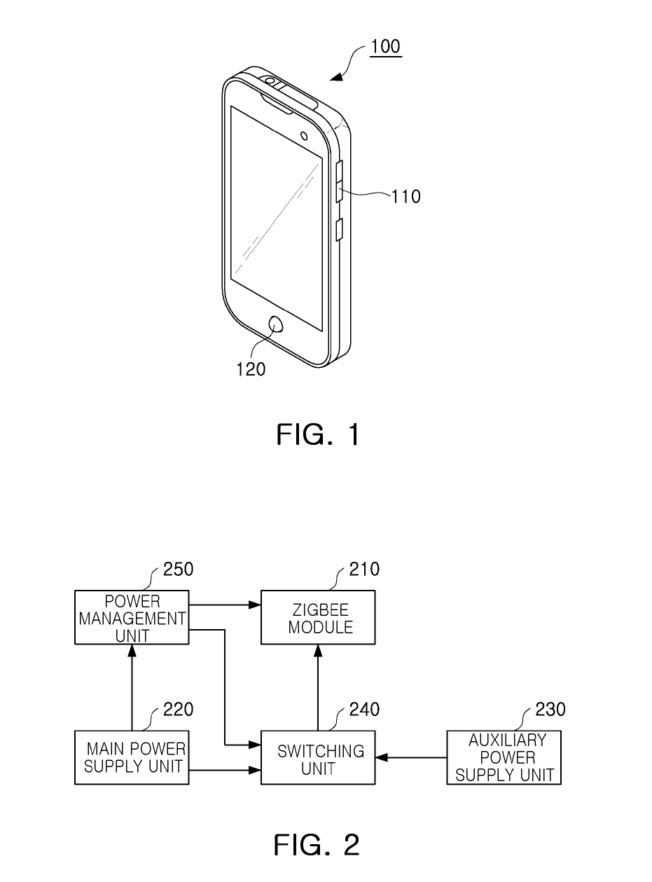

FIG. 1 is a diagram showing an appearance of a mobile device according to an embodiment of the present invention.

Referring to FIG. 1, a mobile device 100 according to an embodiment of the present invention may be a smart phone, personal digital assistants (PDAs), a tablet PC, or the like. In particular, as shown in FIG. 1, the mobile device 100 according to the embodiment of the present invention may include at least one or more input units 110 and 120 that are mechanically operated. This is to secure a command input path for a Zigbee module included in the mobile device 100 even in a case in which residual power of a main power supply unit of the mobile device 100 falls to a predetermined reference value or less, which will be described below.

The mobile device 100 may further include a display unit and an electronic input unit such as a touch screen, or the like, integrally provided with the display unit, in addition to the input units 110 and 120 mechanically operated. In order to diversify the remote control function using the Zigbee module, the mobile device may include the input unit 110, such as a trackball mouse, or the like, which can input turn on/off and direction, in addition to the input unit 120 such as a mechanical dome key that can input only the turn on/off.

FIG. 2 is a block diagram partially showing an inner structure of the mobile device according to an embodiment of the present invention.

Referring to FIG. 2, a mobile device 200 according to an embodiment of the present invention may include a Zigbee module 210, a main power supply unit 220, an auxiliary power supply unit 230, a switching unit 240, and a power management unit 250. The Zigbee module 210 may be a chipset implemented by a system-on-chip (SoC) according to a Zigbee standard and may include a wireless transmitting/receiving unit for communications, a frequency synthesizer, a demodulator/modulator, an oscillator, a regulator, or the like.

The main power supply unit 220 may supply power necessary for a general driving and operation of the mobile device 200 and may be a battery mounted in the mobile device 200. When the mobile device 200 is actually used by a user as well as even when the user does not actually use the mobile device 200, the main power supply unit 220 supplies standby power. A power management unit (PMU) 250 may be responsible for the power management of the main power supply unit 220.

The auxiliary power supply unit 230, which is a power supply unit separately provided from the main power supply unit 220, may be implemented by a small-sized battery having much smaller capacity that that of the main power supply unit 220. For example, the auxiliary power supply unit 230 may be implemented by a coin-type battery and may also be implemented by a very small battery that does not greatly burden a form factor of the mobile device 200 since only very small power (about 20 through 30 mW during the operation in an activated state and 1 through 2 μA based on current in a standby state) necessary for the operation of the Zigbee module 210 is supplied when the residual power in the main power supply unit 220 is a predetermined reference value or less.

The switching unit 240 may be connected between the main power supply unit 220 and the auxiliary power supply unit 230 and the Zigbee module 210 and may control power supplied to the Zigbee module 210. For example, when the residual power in the main power supply unit 220 is sufficient, a power supply path to the Zigbee module 210 through the switching unit 240 from the auxiliary power supply unit 230 may be interrupted by the power management unit 250 and power may be supplied to the Zigbee module 210 from the main power supply unit 220 managed by the power management unit 250.

On the other hand, when the residual power in the main power supply unit 220 is not sufficient, the supply of power from the main power supply unit 220 to the Zigbee module 210 may be interrupted by the power management unit 250, and the supply of power to the Zigbee module 210 through the switching unit 240 from the auxiliary power supply unit 230 may be activated. Therefore, even when the power supply of the mobile device 200 cannot be turned-on since the residual power in the main power supply unit 220 is not sufficient, and also, the Zigbee module 210 is in an inoperable state; the Zigbee module 210 may be supplied with power necessary for the operation from the auxiliary power supply unit 230 to thus provide the remote control function for the external electronic devices.

Meanwhile, the residual power of the main power supply unit 220 may be small not to turn-on the power supply of the mobile device 200 but power that may be sufficient to operate the Zigbee module 210 may also remain in the main power supply unit 220. That is, as described above, since the operation of the Zigbee module 210 only requires the extremely small amount of power, the Zigbee module 210 may be operated by power supplied from the main power supply unit 220 even though the power necessary to turn-on the power supply of the mobile device 200 does not remain in the main power supply unit 220. In this case, the power management unit 250 may determine whether the residual power amount of the main power supply unit 220 is a predetermined reference value or less, to thus control the switching unit 240, thereby selecting and controlling the path supplying power to the Zigbee module 210.

FIG. 2 shows the case in which the auxiliary power supply unit 230 and the switching unit 240 are each mounted outside the Zigbee module 210, but the embodiment of the present invention is not necessarily limited to the above structure. That is, both the auxiliary power supply unit 230 and the switching unit 240 may be mounted within the Zigbee module 210 or any one of the auxiliary power supply unit 230 and the switching unit 240 may be implemented within the Zigbee module 210, such that the hardware may be more freely configured from limitation of the form factor of the overall mobile device 200.

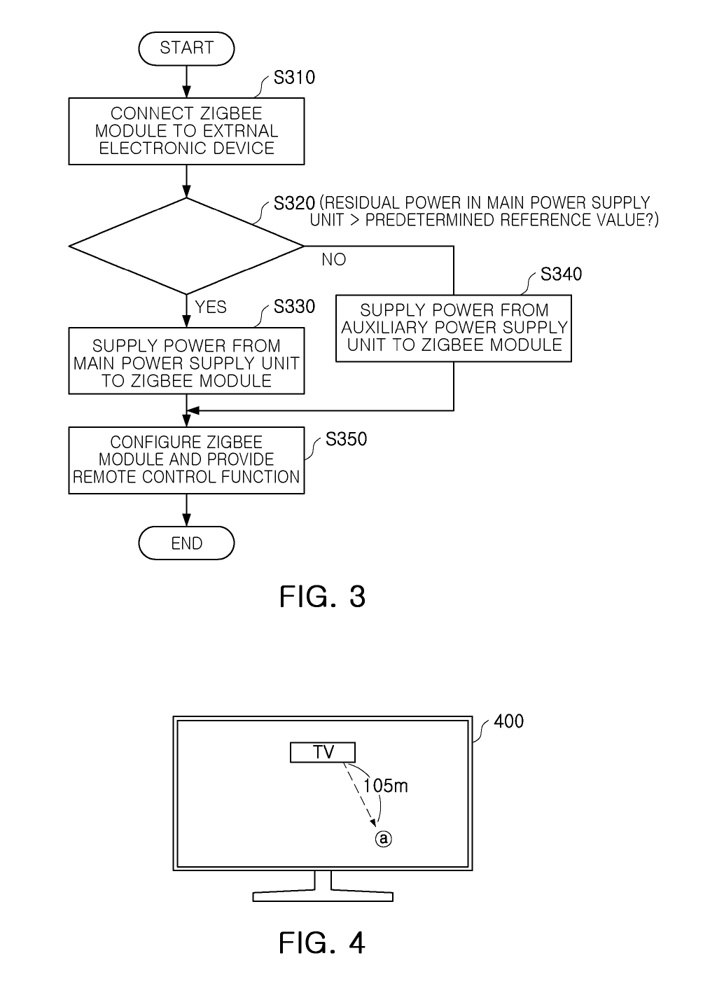

FIG. 3 is a flow chart for explaining an method of operation of the mobile device according to the embodiment of the present invention.

Referring to FIG. 3, the method of operation of the mobile device 200 according to the embodiment of the present invention starts as connecting the Zigbee module 210 to the external electronic devices so that Zigbee module 210 may communicate with the external electronic devices (S300). The external electronic devices may be home appliances, for example, TV, a smart TV, a DVD (Blu-ray) player, a home theater, or the like and the ZigBee module 210 may provide various functions including the remote control function through communication with the external electronic devices.

When the Zigbee module 210 is connected to the external electronic device, the mobile device 200 may provide the remote control function for the external electronic devices according to the user selection, and the power management unit 250 may manage the power supplied to the Zigbee module 210. While the Zigbee module 210 is operated or when the Zigbee module 210 enters the standby state, and then, needs to be activated by receiving the operation command, the power management unit 250 may determine the residual power in the main power supply unit 220 to thus supply power to the Zigbee Module 210 from any one of the main power supply unit 220 and the auxiliary power supply unit 230. To this end, the power management unit 250 may determine whether the residual power amount of the main power supply unit 220 is greater than the predetermined reference value (S310).

As the determination result at S310, when it is determined that the residual power amount of the main power supply unit 220 is greater than the predetermined reference value, the power management unit 250 may control the switching unit 240 to interrupt the path of power supply supplied from the auxiliary power supply unit 230 to the Zigbee module 210, and may directly supply power from the main power supply unit 220 to the Zigbee module 210 (S320). As described above, since the Zigbee module 210 only consumes power of about several tens of milliwatt at the time of the operation and only requires current of about 1 through 2 μA in the standby state, the power supplied from the main power supply unit 220 may operate the Zigbee module 210 when the mobile device 200 may normally be operated due to the sufficient residual power in the main power supply unit 220 as well as even when power that may not turn-on the power supply of the mobile device 200 but may be sufficient to operate the Zigbee module 210 remains in the main power supply unit 220.

As the determination result at 5310, when it is determined that the residual power amount of the main power supply unit 220 is the predetermined reference value or less, the power management unit 250 controls the switching unit 240 to activate the power supply path from the auxiliary power unit 230 to the Zigbee module 210 (S330). Since the main power supply unit is already in the condition that the main power supply unit 220 may not supply power necessary for the operation of the Zigbee module 210 due to the insufficient residual power amount ion the main power supply unit 220, the power management unit 250 may not need to perform a separate control on the power supply path provided from the main power supply unit 220 to the Zigbee module 210.

As such, even when the mobile device 200 may not normally be operated due to the insufficient residual power amount in the main power supply unit 220, the remote control function may be provided by operating the Zigbee module 210 regardless of the turn on/off of the power supply of the mobile device 200 (S340). In this case, when the mobile device 200 may not normally operated, the input unit operated according to the mechanical input scheme, for example, the input unit 110 and 120 of FIG. 1 may be provided so as to secure the input method for the Zigbee module 210.

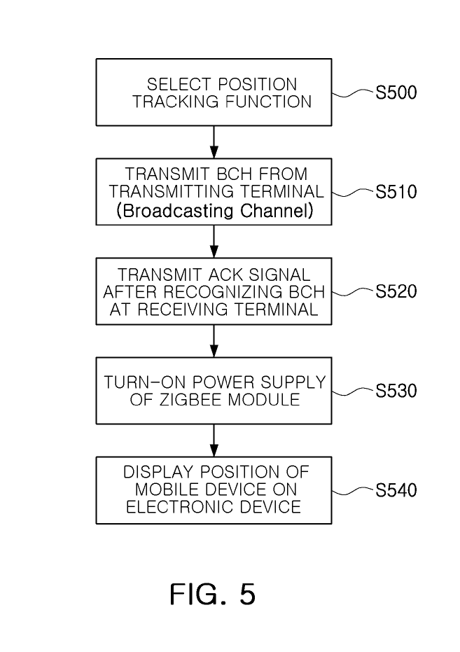

FIGS. 4 and 5 are diagrams schematically showing the method of operation of the mobile device according to the embodiment of the present invention.

FIG. 4 shows an example of a position tracking function of the mobile device 200 under the assumption that the external electronic devices connected to the Zigbee module 210 of the mobile device 200 according to the embodiment of the present invention are video devices such as TV.

When the user unexpectedly lost the mobile device 200, the user may call the lost mobile device 200 using another mobile device when the residual power amount of the main power supply unit 220 of the lost mobile device is sufficient, thereby confirming the position of the mobile device 200. However, when the power supply of the lost mobile device 200 is in a turned-off state due to the insufficient residual power amount in the main power supply unit 220 of the lost mobile device 200, the position of the lost mobile device 200 cannot be confirmed by the above-mentioned method.

When the residual power amount of the Zigbee module 210 and the main power supply unit 220 is not sufficient and when the auxiliary power supply unit 230 capable of being used for the operation of the Zigbee module 210 is provided as described above according to the embodiment of the present invention, the position tracking function for the lost mobile device 200, or the like, may be implemented. Hereinafter, the position tracking function using the Zigbee module 210 will be described with reference to FIGS. 4 and 5.

FIG. 5 is a flow chart for explaining the position tracking function using the Zigbee module 210. Referring to FIG. 5, the user may select the position tracking function in the electronic devices connected to communicate with the Zigbee module 210 (S500). As shown in FIG. 4, when an electronic device 400 connected to the Zigbee module 210 is TV, the user may select the position tracking function in TV.

When the position tracking function is selected, the electronic device 400 connected to the Zigbee module 210 of the mobile device 200 may transmit a signal for position tracking, for example, a BCH signal, from a transmitting terminal Tx to the Zigbee module 210 (S510). The Zigbee module 210 may recognize the BCH signal according to the signal transmitted from the transmitting terminal of the electronic device 400 and may transmit an ACK signal to the electronic device 400 in response thereto (S520), and the power supply thereof may be turned-on by power supplied from the auxiliary power supply unit 230 (S530).

The electronic device 400 may detect the approximate position of the Zigbee module 210, that is, the mobile device 200 by turning-on the power supply of the Zigbee module 210 and the ACK signal transmitted to the electronic device 400 side. As shown in FIG. 4, when the position of the mobile device 200 is detected, the relative distance and position of the mobile device 200 may be approximately displayed (position A displayed on a screen of FIG. 4) on a screen based on the electronic device 400 receiving the ACK signal, thereby informing the user of the position of the mobile device 200 (S540).

As set forth above, the embodiments of the present invention can provide the remote control function for external electronic devices and the position tracking function using the mobile device even when there is no residual power in the main power supply unit, by selecting and controlling the power supply source supplying power to the Zigbee module through the switching unit provided between the main power supply unit and the auxiliary power supply unit.

Hereinabove, although the present invention is described by specific matters such as concrete components, and the like, embodiments, and drawings, they are provided only for assisting in the entire understanding of the present invention. Therefore, the present invention is not limited to the embodiments. Various modifications and changes may be made by those skilled in the art to which the present invention pertains from this description.

Therefore, the spirit of the present invention should not be limited to the above-described embodiments, and the following claims as well as all modified equally or equivalently to the claims are intended to fall within the scope and spirit of the invention.

What is claimed is:

1. A mobile device, comprising:
a power supply unit;
a Zigbee module operated by power supplied from the power supply unit and connected to an external electronic device so as to communicate with the external electronic device, to thereby provide a remote control function; and
a switching unit controlling a connection between the power supply unit and the Zigbee module;
the power supply unit including a main power supply unit and an auxiliary power supply unit supplying power to the Zigbee module when residual power in the main power supply unit falls to a predetermined reference value or less.

2. The mobile device of claim 1, wherein the auxiliary power supply unit is disposed in the Zigbee module.

3. The mobile device of claim 1, wherein the switching unit is disposed in the Zigbee module.

4. The mobile device of claim 1, wherein the switching unit connects the auxiliary power supply unit to the Zigbee module so that the Zigbee module receives power supplied from the auxiliary power supply unit when the residual power in the main power supply unit is 5% or less.

5. The mobile device of claim 1, wherein the switching unit connects the main power supply unit to the Zigbee module so that the Zigbee module receives the power supplied from the main power supply unit when the residual power in the main power supply unit is 5% or more.

6. The mobile device of claim 1, wherein the Zigbee module transmits a signal in response to a position tracking signal to the external electronic devices when receiving the position tracking signal from the external electronic devices.

7. The mobile device of claim 1, further comprising a mechanical input unit controlling an operation of the remote control function provided by the Zigbee module.

8. A method of operation of a mobile device including a Zigbee module, the method of operation comprising:
confirming residual power of a main power supply unit;
supplying power to the Zigbee module from at least one of the main power supply unit and an auxiliary power supply unit according to the residual power in the main power supply unit; and
providing a remote control function for external electronic devices by connecting the external electronic devices to the Zigbee module so as to communicate with each other.

9. The method of claim 8, wherein the supplying of the power includes supplying the power from the auxiliary power supply unit to the Zigbee module when the residual power in the main power supply unit is at a predetermined reference value or less, and supplying the power from the main power supply unit to the Zigbee module when the residual power in the main power supply unit is at the reference value or more.

10. The method of claim 9, wherein the reference value is 5% of maximum power of the main power supply unit.

11. The method of claim 8, further comprising transmitting a signal in response to a position tracking signal to the external electronic devices when receiving the position tracking signal from the external electronic devices.
